(19) United States
(12) Patent Application Publication
(10) Pub. No.: US 2023/0109067 A1
(43) Pub. Date: Apr. 6, 2023

(54) Unclonable Security for Additive Manufacturing Using Material Designed for a Physical Unclonable Function

(71) Applicant: Lexmark International, Inc., Lexington, KY (US)

(72) Inventors: James Paul Drummond, Georgetown, KY (US); Cory Nathan Hammond, Winchester, KY (US); Kelly Ann Killeen, Lexington, KY (US); Gary Allen Denton, Lexington, KY (US)

(21) Appl. No.: 18/078,448

(22) Filed: Dec. 9, 2022

Related U.S. Application Data
(62) Division of application No. 16/820,995, filed on Mar. 17, 2020.
(60) Provisional application No. 62/822,530, filed on Mar. 22, 2019.

(51) Int. Cl. B29C 64/118; H04L 9/32; B29C 31/04; B29C 64/393; B33Y 10/00; B33Y 70/00

(52) U.S. Cl. CPC B29C 64/118; H04L 9/3278; B29C 31/04; B29C 64/393; B33Y 10/00; B33Y 70/00

(57) ABSTRACT

Disclosed is a process of adding PUF materials with non-repeatable random order to the additive manufacturing process of a product. Preferably, these materials have magnetic characteristics. These characteristics can be detected by a sensor which reads the random pattern and provides a unique signature for the item produced.

### CROSS REFERENCES TO RELATED APPLICATIONS

This application claims priority as a divisional application to U.S. non-provisional application Ser. No. 16/820,995, filed Mar. 17, 2020, titled “Unclonable Security for Additive Manufacturing Using Material Designed for Physically Unclonable Function (PUF),” the content of which is hereby incorporated by reference herein in its entirety.

### BACKGROUND

This invention to the addition of physical unclonable function (“PUF”) materials to the additive manufacturing process to create a security element of a unique signature for the item.

### SUMMARY

The present disclosure relates generally to the addition of PUF materials with non-repeatable random order to the additive manufacturing process of a product. Preferably, these materials have magnetic characteristics. These characteristics can be detected by a sensor which reads the random pattern and provides a unique signature for the item produced.

### BRIEF DESCRIPTION OF THE DRAWINGS

The above-mentioned and other features and advantages of the disclosed embodiments, and the manner of attaining them, will become more apparent and will be better understood by reference to the following description of the disclosed embodiments in conjunction with the accompanying drawings.

FIG. 1 shows a flow chart of the process that adds PUF materials to additive manufacturing.

### DETAILED DESCRIPTION

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting. As used herein, the terms “having,” “containing,” “including,” “comprising,” and the like are open ended terms that indicate the presence of stated elements or features, but do not preclude additional elements or features. The articles “a,” “an,” and “the” are intended to include the plural as well as the singular, unless the context clearly indicates otherwise. The use of “including,” “comprising,” or “having,” and variations thereof herein is meant to encompass the items listed thereafter and equivalents thereof as well as additional items.

Terms such as “about” and the like have a contextual meaning, are used to describe various characteristics of an object, and such terms have their ordinary and customary meaning to persons of ordinary skill in the pertinent art. Terms such as “about” and the like, in a first context mean “approximately” to an extent as understood by persons of ordinary skill in the pertinent art; and, in a second context, are used to describe various characteristics of an object, and in such second context mean “within a small percentage of” as understood by persons of ordinary skill in the pertinent art.

Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings. Spatially relative terms such as “top,” “bottom,” “front,” “back,” “rear,” and “side,” “under,” “below,” “lower,” “over,” “upper,” and the like, are used for ease of description to explain the positioning of one element relative to a second element. These terms are intended to encompass different orientations of the device in addition to different orientations than those depicted in the figures. Further, terms such as “first,” “second,” and the like, are also used to describe various elements, regions, sections, etc., and are also not intended to be limiting. Like terms refer to like elements throughout the description.

Additive manufacturing is technology that builds three-dimensional (“3D”) objects by adding layer-upon-layer of material. The focus on additive manufacturing and move of additive manufacturing into higher value parts has placed an increasing focus on the legitimacy of the parts produced. Additive manufacturing in some sense has become almost an art form, where each part can be unique, and each part may have indistinguishable differences from a similarly designed part that makes it unique, or functional.

In this world where additive manufacturing equipment is easily obtained, it has become easy for illegitimate manufacturers to scan and reproduce parts that look indistinguishable from a legitimately produced part, but might have significant differences that may cause problems, failures, harm, or even loss of life in cases like aircrafts. This can cause significant risk to the profits of businesses using additive manufacturing, but also could create dangerous situations if cloned parts make it into safety critical applications.

The invention described here is the inclusion of randomly placed particles into additively manufactured products to produce durable identifying markers that indicate a product's legitimacy. By incorporation of a marker into the body of the additively manufactured product, the designer or artist can create a unique irreproducible signature that defines that product as the original, made by the original artist or manufacturer.

The prior art U.S. Pat. No. 9,656,428 presents the incorporation of conductive traces which might form an RFID signature for a 3D printed object. In other research, Chen, et al., have proposed methods of laying out and incorporating a quick reference (“QR”) code into a 3D printed product. (See Chen et al., Tech briefs 2018).

In these two described methods, the chosen identification device is designed in a specific location in the part, and thus the structure of the identification device is designed and printed by the additive manufacturing technique. This allows for the identification of the product but would also then allow one with diagnostic capability to reverse engineer the location and structure of the device, then additively manufacture a similar product with the device incorporated. While this may add difficulty and cost for the counterfeiter, it would not prevent reproduction of the product.

Here we describe the addition of materials with non-repeatable random order to the additive manufacturing process of a product. These materials have features which make them distinguishable from the bulk material. The particles by nature of their random orientation in the production technique produce randomly oriented properties in random locations. In the preferred embodiment these materials have magnetic characteristics. These characteristics can be detected by a sensor which reads the random pattern and provides a unique signature for the item produced. In this method, the random materials can be added to the entire product produced by the process, or the particles can be added to a small subsection of the item where reading is to take place.

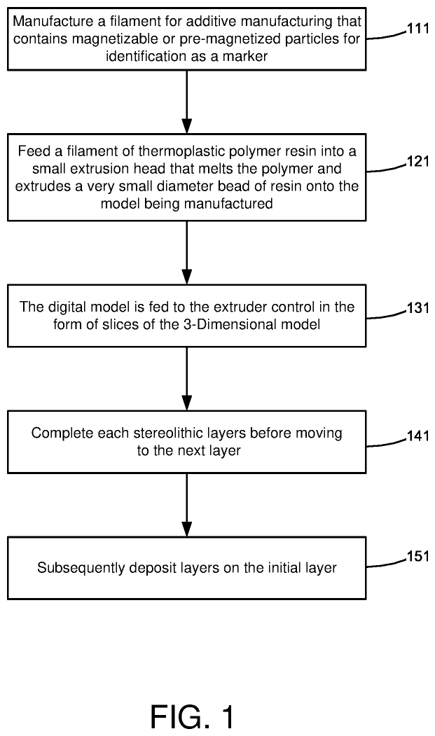

In a preferred embodiment shown in FIG. 1, the active material chosen would be a highly magnetic material particles. Magnetic materials like neodymium iron boron (“NdFeB”) has the desired properties, but other materials such as, but not limited to, samarium cobalt (“SmCo”) might also be used. The particles may be powder-sized. These types of materials can be compounded into filament or pellets of amorphous or semi-crystalline thermoplastic resins 111. It is also foreseen that these types of material can be incorporated into precursor resins for thermosetting polymers as well. These material particles can be pre-magnetized in preparation for use in the additive manufacturing process, rendering them highly magnetic, and providing strong, readable, stable signals for creating a signature for the resulting part.

In further discussion of a preferred embodiment shown in FIG. 1, the manufacturer could use an additive manufacturing technique described as fused deposition modeling (“FDM”). In this technology, a filament of thermoplastic polymer resin is fed into a small extrusion head which melts the polymer and extrudes a very small diameter bead of resin onto the model being manufactured 121. The digital model is fed to the extruder in the form of slices of the 3-dimensional model 131. The extruder usually completes each of these stereolithic layers before moving to the next layer 141. The model is then constructed by subsequent deposition of layers onto the initial layers 151. In this method, the filament used can be manufactured to contain the desired particles for identification.

In one embodiment, these particles might be magnetic particles. They may also be pre-magnetized particles. When the filament is fed into the extrusion unit, the resin becomes a viscous fluid, and the resin/particle mixture is deposited in random order onto the product, creating a layer of resin with random particle inclusion. This method can be used to produce a solid model from the digital model designed on the computer system. In that model, the designer/manufacturer may decide to include the particles only in one particular part of the item or use that resin to produce the entire item. Dual nozzle systems can be found to make this process more convenient. In a variation on this FDM technique, an FDM machine can also be designed to feed pellets of resin to the extrusion head under pressure. Thus, FDM methods may require polymer resin filament or pelletized resin with pre-magnetized particles

In another chosen embodiment the manufacturer may select a manufacturing technique called laminated object manufacturing (LOM) to produce three dimensional items. In this technology, layers of thin film are excised in the shape of each individual slice of the 3D model. These layers are then laminated together by heat, solvent, or other methods to produce a solid model. This method can be used for a wide variety of materials. All layers, one layer, or part of a layer may be made from film containing random magnetized particles. This layer would thus produce an identifiable signature within the 3D model which cannot be reproduced.

In a further embodiment it can be imagined a system where laser sintering is used to turn powdered material into a solid object. The technique is also used with many material types. In this method, it can be conceived that each layer of powdered material is sintered by the laser to become part of the solid. In this process a powder layer with different and/or random magnetic properties is substituted for the standard powder material, and when sintered forms a layer with unique magnetic properties within the three-dimensional object. This layer then creates a signal which can be identified by a sensor. In this method, the material with magnetic signature is random, and incorporated into the completed solid part.

### Design of PUF Material

In the development of PUF into a material, it is necessary to develop properties which are completely random when manufactured, but not just any random property is sufficient. The property has to be stable enough to not be disturbed, and unique enough that it is nearly impossible to replicate. If one develops a property that is randomly varying, but the property is easily disturbed then the characteristic values of the property may change over time. This is the fault found in some early magnetic PUF ideas.

To protect against such changes the property must be durable at reasonable conditions. This however is still not enough to make a useful PUF. A property that is random and durable, but is relatively easy to re-create, will allow a cloner to repeat that PUF many times and counterfeit a signal to match.

If, however, the property is randomly created in manufacturing, durable and sufficiently difficult to recreate, the material then becomes very useful for creating a PUF device. This is the basis for the novel materials described here.

Described are designed materials which rely on highly stable magnetic substances as a starting point for a PUF material. What properties the materials produce in the PUF is an important factor, i.e., a highly varying sets of properties that are random when manufactured yet gave a distinct signal when measured.

In one preferred embodiment a solid body is designed with a magnetic signal. The magnetic signal from the material has a variation along the body. That maximum variation in magnetic signal when measured along the body can be up to ±100 gauss but no less than ±5 gauss. Not only is this a large variation in magnetic signal along the body, but it is also an extreme rate of change in the magnetic signal. Swings in the signal may be from (+100) gauss to (−100) gauss over a distance of less than 0.5 mm.

The creation of materials with these properties provides a good basis for creating an unclonable PUF material. In order to make the PUF tamper proof, materials were selected to create the body that withstand temperatures up to 300° C. without altering the magnetic signature, effectively making it thermally durable.

Materials were also chosen to minimize the effects of any external electrical or magnetic fields. These materials should have a coercivity of 500 oersted or greater in order to protect the materials from magnetic field disruption.

Having a very random, durable, and complicated magnetic signal makes a material a novel candidate for use in security devices. In order to make it more complex, other features were incorporated into the material to complicate remanufacture. Through design of the material and processing, each of the previously stated properties (high maximum variation, high rate of field change, extreme temperature, and electro-magnetic field resistance) were incorporated into the three-coordinate axis of the material. High variability and rate of change of field can be measured in X, Y, and Z directions. This allows the exponential increase of the security of a device built from this type of material.

In initial studies, materials which varied in color were considered. Further, materials that varied in brightness and particle directional orientation were considered. Consideration was also made for the roughness or texture of a material as an unclonable feature. In many of these instances it was found that the properties might be easily alterable or easily repeatable by an individual attempting to clone the device. Other options investigated included other active and passive magnetic materials. It is common in industry to use either permanent magnets for magnetic properties, or it is also common to use rewritable magnetic materials for creating readable signatures for incorporating data. Here, however, a random magnetic field was created using permanent magnets specifically designed to give a unique signal, but also be non-rewritable, and unaffected by normal conditions.

There is prior art for 2-D writable magnetic strips as well as using magnetic materials to create identification items. However, the use of a non-writable, three-dimensional, high magnitude, random magnetic signal as an identifier is unique.

The foregoing description of embodiments has been presented for purposes of illustration. It is not intended to be exhaustive or to limit the present disclosure to the precise steps and/or forms disclosed, and obviously many modifications and variations are possible in light of the above teaching. It is intended that the scope of the invention be defined by the claims appended hereto.

We claim:

1. An additive manufactured product comprising:
inclusions of randomly placed particles in the product that produce durable identifying markers indicating legitimacy of a product;
where the particles are highly magnetic material particles.

2. The product of claim 1, wherein the particles contain neodymium iron boron.

3. The product of claim 1, wherein the particles contain samarium cobalt.

4. The product of claim 1, wherein the particles are pre-magnetized.
